(19) United States
(12) Patent Application Publication
(10) Pub. No.: US 2010/0032414 A1
(43) Pub. Date: Feb. 11, 2010

(54) INERT GAS MIXTURE AND METHOD FOR WELDING

(76) Inventors: Nikolai Arjakine, Berlin (DE); Rolf Wilkenhöner, Kleinmachnow (DE); Manuela Zinke, Magdeburg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/532,489

(22) PCT Filed: Mar. 23, 2007
(86) PCT No.: PCT/EP2007/002608

§ 371 Date: Sep. 22, 2009

(51) Int. Cl. B23K 9/16

(52) U.S. Cl. 219/75

(57) ABSTRACT

An inert gas mixture including helium and nitrogen or helium and hydrogen or helium, hydrogen, and nitrogen for use during the welding of a nickel-based or cobalt-based substrate is provided. Also provided is a method for the welding of a substrate in which an inert gas mixture is used. The substrate used in the method may be nickel-based or cobalt-based.

### CROSS REFERENCE TO RELATED APPLICATIONS

This application is the US National Stage of International Application No. PCT/EP2007/002608, filed Mar. 23, 2007 and claims the benefit thereof.

### FIELD OF INVENTION

The invention relates to an inert gas mixture as claimed in the claims and to a process for welding as claimed in the claims.

### BACKGROUND OF INVENTION

Components exposed to mechanical and/or thermal stresses, e.g. components of a gas or steam turbine, often have cracks after they have been used.

However, it is possible to reuse components of this type if the substrates of the components are repaired. The cracks are repaired, for example, by being welded closed or by build-up welding.

Nickel-based superalloys may form cracks when they are being joined by welding. The cracks which develop are referred to as hot cracks.

In principle, a distinction can be made between several types of hot cracks (Instruction sheet DVS 1004-1: Heiβrissprüfverfahren—Grundlagen [The Principles of Hot Crack Testing Processes], Düsseldorf, Deutscher Verband für Schweiβtechnik [German Welding Society], November 1996).

By way of example, the grain boundaries (microstructure region) melt during welding since the material can partially melt in those microstructure regions which have a solidus temperature that is below the equilibrium solidus temperature of the average composition of the alloy. These microstructure regions include phases which have already evolved during the production of the material (e.g. low-melting sulfides, primary carbides or borides) or else phases which form on account of segregation during the solidification of the molten base material and—if the weld filler is of the same type—of the weld metal.

Depending on the time at which they arise, it is possible to distinguish between solidification cracks and remelting cracks.

Cracks produced by a dip in ductility at high temperatures (DDC, Ductility Dip Cracks) may be at a larger distance from the fusion line. They are formed at temperatures below those required in order for remelting cracks to appear. The result of the dip in ductility may be that contraction stresses result in the initiation of cracks during cooling.

Occupancy of the grain boundaries by foreign phases (e.g. carbides) may promote the formation of hot cracks. By way of example, this is the case when the shape of the phases means that they act as internal notches, and contraction stresses are therefore more likely to lead to the formation of cracks. This is also the case when the foreign phases melt at lower temperatures than the base material such that films of liquid form on the grain boundaries (constitutional melting of carbides, sulfides or borides etc.).

A further problem with the build-up welding of superalloys is possible oxidation of the weld joint during welding. Oxidation of the weld joint makes it harder to weld large areas by overlapping or multi-layered welding of individual beads since it becomes increasingly difficult to bond the individual beads to one another. Bonding defects which impair the mechanical integrity of the weld may arise. In addition, oxygen leads to intercrystalline corrosion along the grain boundaries of the weld joint. The grain boundaries are thereby weakened and embrittled, and this promotes the formation of cracks on the grain boundaries and impairs the mechanical properties.

The effect of reducing the susceptibility to hot cracking by adding nitrogen to the inert gas is described in the literature for the solid-solution-hardened alloy NiCr25FeAlY (2.4633) (DVS-Volume 225 (2003), pages 249-256).

EP 0 826 456 B1 discloses an inert gas mixture containing 2.0%-3.7% N₂ and 0.5%-1.2% H₂ for the TIG welding of austenitic steels, wherein the austenite forms poorly at the welding temperatures during cooling (excessively quick cooling). In this case, the nitrogen is added in order to reduce the ferrite content at the weld joint of corrosion-resistant, austenitic steels, since nitrogen is known as an austenite-forming agent, because the undesirable δ ferrite phase is shifted in the phase diagram towards higher temperatures by nitrogen, and therefore the phase region of γ austenite is increased and therefore formed preferentially. Hydrogen is added in order to increase the service life of the tungsten electrode.

EP 0 163 379 A2 discloses a welding process in which nitrogen is added to the inert gas. The nitrogen is only added because alloys containing nitrogen (0.15% by weight-0.25% by weight) are welded during the process.

U.S. Pat. Nos. 5,897,801, 5,554,837, 5,374,319, 5,106,010, 6,124,568, 6,333,484, 6,054,672 and 6,037,563 disclose processes and devices for welding metals.

EP 0 673 296 B1 discloses the use of argon or argon/helium mixtures during welding.

EP 1 595 633 A1 discloses an inert gas mixture consisting of argon and nitrogen.

DE 197 48 212 A1 discloses a large number of inert gas mixtures and inert gases.

U.S. Pat. No. 6,024,792 discloses a build-up welding process. In the build-up welding process, a laser beam or electron beam is used in order to melt powder.

### SUMMARY OF INVENTION

Therefore, it is an object of the invention to overcome the susceptibility to cracking after welding by reducing oxide formation and the formation of low-melting crystalline or amorphous phases, e.g. oxides, borides, carbides, nitrides, oxycarbonitrides, on the grain boundaries.

A further object of the invention is to improve the resistance to hot cracking.

The object is achieved by an inert gas mixture as claimed in the claims and by a process for welding as claimed in the claims.

The dependent claims list further advantageous measures.

The measures listed in the dependent claims can advantageously be combined with one another.

### BRIEF DESCRIPTION OF THE DRAWINGS

FIGS. 1, 2, 3 show a component 1 which is treated by means of the process according to the invention,

FIG. 4 shows a component 1 after the process has ended,

FIG. 5 shows a list of alloys that can be used,

FIG. 6 shows a turbine blade or vane as an exemplary component, and

FIG. 7 shows a gas turbine.

### DETAILED DESCRIPTION OF INVENTION

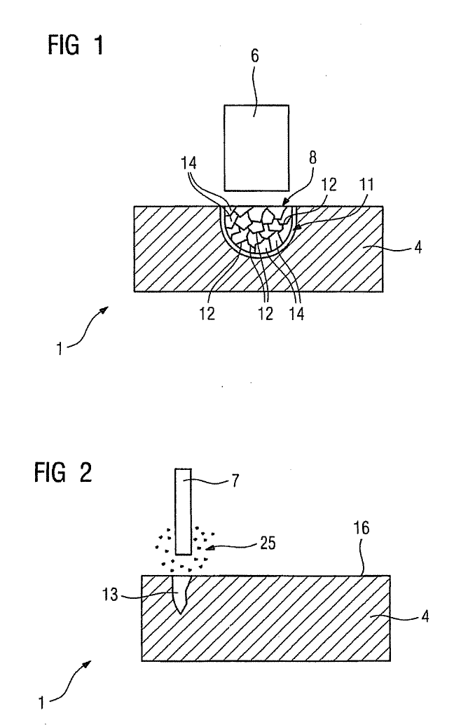

FIG. 1 shows a component 1 having a substrate 4 with a weld seam 8 which has been produced using a tungsten anode 6. The weld seam 8 of the weld joint 11 in the substrate 4 consists of grains 14.

The use of helium and/or nitrogen and/or hydrogen in the inert gas reduces or prevents the formation of low-melting phases on the grain boundaries 12 (and not in the grains 14), which delimit the grains 14.

Only the use of helium without the admixture of other inert gases makes it possible to achieve the advantages mentioned below for the stated materials.

This advantage far outweighs the use of the much more expensive helium (compared with argon).

This is particularly astonishing since argon and helium are noble gases. However, it has advantageously been found that the introduction of energy is improved when helium is used, even though helium has a higher ionization energy than argon.

In the nickel- or cobalt-based materials used here, the nitrogen does not influence the phase formation in the grains of the material, which are austenites, since the iron content is less than 1.5% by weight or in particular iron is not present at all as an alloying constituent (Fe≈0%), but rather is present at most in the form of undesirable impurities.

In addition, the nickel- or cobalt-based materials very preferably form stable austenites, such that it is not necessary to use austenite-forming agents such as nitrogen during welding.

Since the iron content is low, or iron is not present at all, the formation of ferrites particularly in the nickel- or cobalt-based materials is not a problem here either (no ferrites are formed).

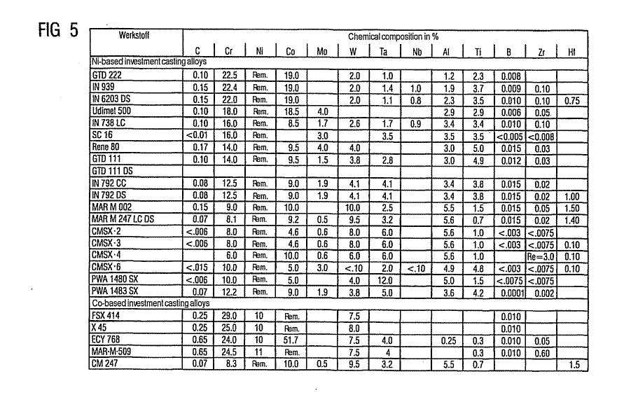

FIG. 5 shows a list of those materials for which the inert gas can be used.

It is likewise not desirable for nitrogen to be present in the alloys as an alloying constituent (max. 100 ppm).

FIG. 2 shows a component 1 which is treated by means of the process according to the invention.

The component 1 has a substrate 4 which, in particular, consists of a nickel- or cobalt-based superalloy and not an iron-based alloy. The alloy of the component 1 or of the superalloy is precipitation hardened.

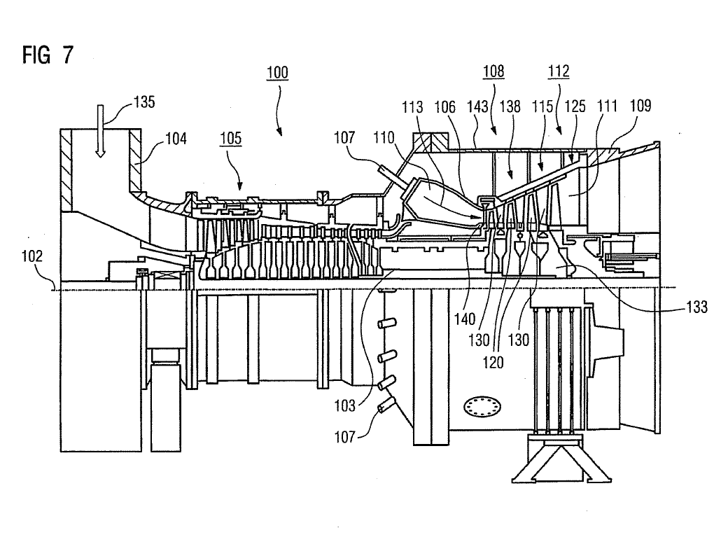

By way of example, the component 1 is a turbine blade or vane 120, 130 (FIG. 7) of a turbine, in particular of a gas turbine 100 (FIG. 8) for a power plant or an aircraft.

After production or after use, the substrate 4 has a crack 13 which is intended to be repaired.

This can be done by using an electrode 7, for example also a tungsten electrode, or a laser or electron beam 7 to close the crack 13.

If electrodes are used during welding, it is also possible to use electrodes other than tungsten electrodes.

In this case, use is made of the inert gas 25 according to the invention; this inert gas is washed around the crack 13 or is present in a box (not shown) surrounding the crack 13.

FIG. 3 shows a component 1 which is likewise treated by means of a further process according to the invention.

The substrate 4 has a region 19 (depression) which had, for example, a crack or corroded surface regions. These have been removed and have to be filled with new material 28 up to the surface 16 of the substrate 4 in order for the component 1 to be reused.

This is carried out, for example, by build-up welding. By way of example, this process involves the use of a powder feeder 11 to supply material (welding material) 28 to the region 19 which is melted by a welding electrode 7 or a laser 7.

This can be carried out in the manner described in the prior art (U.S. Pat. No. 6,024,792).

However, the inert gas mixture 25 according to the invention, which surrounds or washes around the molten or hot regions 19, is used to reduce the formation of oxides and/or low-melting phases on the grain boundaries 12.

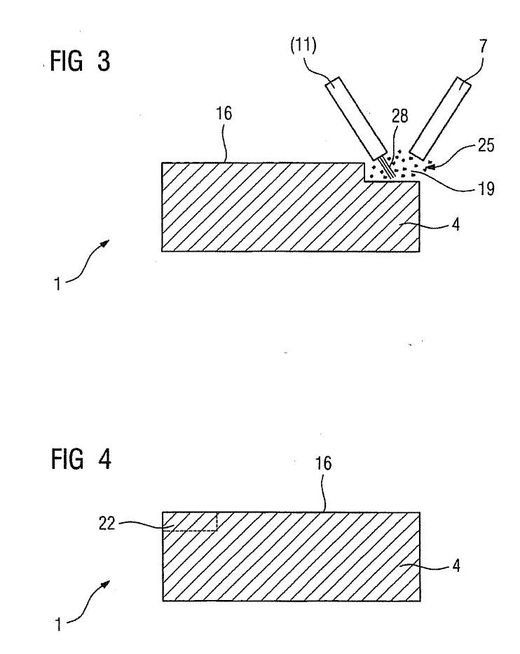

FIG. 4 shows a component 1 after the process shown in FIG. 1 or 2 has been carried out.

The substrate 4 no longer has any cracks 13 or regions 19 which have been removed. Dashes are used to show that region 22 in which cracks 13 were previously present or material was removed.

The component 1 can now be reused like a newly produced component and be recoated.

A possible way of avoiding hot cracks in the processes shown in FIG. 3 or 4 is to reduce the temperature gradient and therefore the stress gradient between the weld joint and the rest of the component. This is achieved by preheating the component during welding, for example during manual TIG welding in an inert gas box, wherein the weld joint is preheated inductively (by means of induction coils) to temperatures above 900° C.

The inert gas 25 used during the welding process contains proportions of nitrogen and/or hydrogen and/or the inert gas helium.

The hydrogen in the inert gas 25 bonds with oxygen which originates from the alloy or the surrounding area. This prevents or reduces the oxidation of the weld metal. This makes it possible to provide good quality, large-area welds without machining each previously applied welding bead (in this context, a surface of a welding bead also represents a grain boundary 12) in order to remove the tarnished/oxidized regions. Intercrystalline corrosion, which would weaken the grain boundaries, is prevented at the same time. This reduces the susceptibility to cracking and the mechanical properties of the materials are improved.

Additions of hydrogen in the range from 0.3% by volume to 25% by volume, in particular from 0.5% by volume to 3% by volume or of about 0.7% by volume, are suitable for this purpose.

Nitrogen may suppress or reduce the formation of coarser primary carbides on the grain boundaries, for example. Fewer and finer primary carbides are formed. To some extent, carbonitrides are more likely to be formed as primary carbides. This too reduces the susceptibility to hot cracking. Additions of nitrogen in the range from 1% by volume to 20% by volume, in particular from 1% by volume to 12% by volume or of about 3% by volume, are suitable.

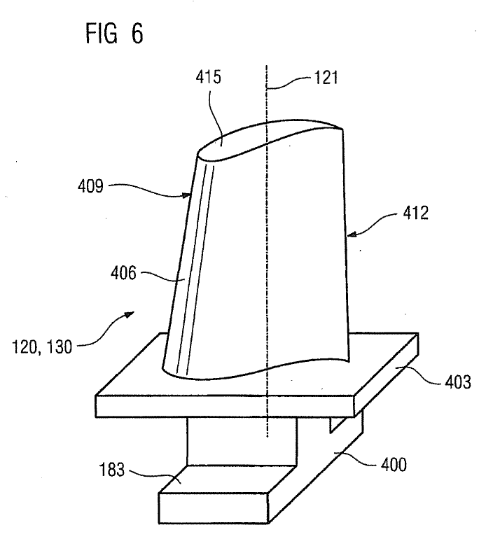

The use of this specific inert gas 25 reduces the susceptibility to hot cracking during the welding of nickel- or cobalt-based superalloys (FIG. 6) and at the same time protects the component against oxidation.

One application example is the homogeneous welding of the alloy Rene 80, a precipitation hardened nickel-based material, by means of manual plasma-arc powder surfacing.

The aim is to repair gas turbine blades or vanes which are subject to operational stresses by means of welding. The welded repair is intended to have properties in the region of the base material, such that homogeneous welding has to be carried out.

The inert gas 25 used in this case is a mixture of 96.3% by volume He, 3% by volume N₂ and 0.7% by volume H₂. A significantly reduced susceptibility to hot cracking is achieved together with reduced oxidation of the weld metal, as compared with the conventional inert gas He 5.0 (He>99.999% purity). The advantages of the weld seam produced outweigh the fact that helium is a very expensive gas.

The following table lists weld fillers SC60 and SC60+ which are preferably used.

| Element | SC 60 | SC 60+ | Effect |
|---|---|---|---|
| Cr | 18.0-20.0 | 18.0-20.0 | Corrosion resistance, increases the |
| | | | resistance to sulfidation, solid |
| | | | solution hardening |
| Co | 9.0-11.0 | 9.0-11.0 | Reduces the stacking fault energy, |
| | | | resulting in increased creep |
| | | | strength, improves the solution |
| | | | annealing properties |
| Mo | 7.0-10.0 | 7.0-10.0 | Solid solution hardening, increases |
| | | | the modulus of elasticity, reduces |
| | | | the diffusion coefficient |
| Ti | 2.0-2.5 | 2.0-2.5 | Substitutes Al in γ′, increases the γ′ |
| | | | volume proportion |
| Al | 1.0-1.7 | 1.0-1.7 | γ′ formation, only effective |
| | | | long-term protection against |
| | | | oxidation at > approx. 950° C., |
| | | | strong solid solution hardening |
| Fe | max 1.5 | max 0.5 | Promotes the formation of TCP |
| | | | phases, has an adverse effect on |
| | | | resistance to oxidation |
| Mn | max 0.3 | max 0.15 | |
| Si | max 0.15 | max 0.1 | Promotes the formation of TCP |
| | | | phases, increases hot cracking |
| C | 0.04-0.08 | 0.06 | Carbide formation |
| B | 0.003-0.007 | max 0.001 | Element with grain boundary |
| (optional) | | | activity (large atom), increases the |
| | | | grain boundary cohesion, reduces |
| | | | the risk of incipient cracking, |
| | | | increases the ductility and creep |
| | | | rupture strength, prevents the |
| | | | formation of carbide films on |
| | | | grain boundaries, reduces the |
| | | | risk of oxidation |
| Ni | Remainder | Remainder | |

The next table lists further weld fillers SC52 and SC52+ which are used with preference.

| Element | SC 52 | Variant SC 52+ | Effect |
|---|---|---|---|
| Cr | 17.5-20.0 | 17.5-20.0 | Corrosion resistance, increases the |
| | | | resistance to sulfidation, solid solution |
| | | | hardening |
| Co | 10.0-12.0 | 10.0-12.0 | Reduces the stacking fault energy, |
| | | | resulting in increased creep strength, |
| | | | improves the solution annealing |
| | | | properties |
| Mo | 9.0-10.5 | 9.0-10.5 | Solid solution hardening, increases the |
| | | | modulus of elasticity, reduces the |
| | | | diffusion coefficient |
| Ta | 0 | 0.1 to 2.5 | Substitutes Al in γ′, increases the γ′ |
| | | | solution temperature, delays the γ′ |
| | | | coarsening |
| Ti | 3.0-3.3 | 0.1 to 1.5 | Substitutes Al in γ′, increases the γ′ |
| | | | volume proportion |
| Ti + Ta | — | 3 ≦ (Ti + Ta) ≦ 3.5 | |
| Al | 1.4-1.8 | 1.4-1.8 | γ′ formation, only effective long-term |
| | | | protection against oxidation at > |
| | | | approx. 950° C., strong solid solution |
| | | | hardening |
| Fe | max 5 | max 0.35 | Promotes the formation of TCP |
| | | | phases, has an adverse effect on |
| | | | resistance to oxidation |
| Mn | max 0.1 | max 0.05 | |
| Si | max 0.5 | max 0.1 | Promotes the formation of TCP |
| | | | phases, increases hot cracking |
| C | 0.04-0.12 | 0.04-0.12 | Carbide formation |
| B | 0.003-0.01 | 0.003-0.01 | Element with grain boundary activity |
| | | | (large atom), increases the grain |
| | | | boundary cohesion, reduces |
| | | | the risk of incipient cracking, |
| | | | increases the ductility and creep |
| | | | rupture strength, prevents the |
| | | | formation of carbide films on grain |
| | | | boundaries, reduces the risk of |
| | | | oxidation |
| Zr | 0 | 0.01-0.1 | Bonds with S and C, increases the |
| | | | resistance to hot cracking |
| Hf | 0 | 0.25-0.5 | Reduces the hot cracking during |
| | | | casting, is incorporated in γ′, |
| | | | increases its strength, improves the |
| | | | resistance to oxidation |
| La | 0 | 0.05-0.1 | Bonds with S, increases the resistance |
| | | | to hot cracking |
| S | max 0.015 | max 0.0075 | |
| P | max 0.03 | max 0.015 | |
| Ni | Remainder | Remainder | |

One application example is the welding of the alloy Rene 80, in particular when subject to operational stresses, by means of manual TIG welding and plasma-arc powder surfacing. Further welding processes and repair applications are not ruled out. The weld repair joints have properties which allow “structural” repairs in the airfoil/platform transition radius or in the airfoil of a turbine blade or vane.

Other nickel-based fillers can be selected according to the level of the γ′ phase, specifically for preference greater than or equal to 35% by volume, with a preferred maximum upper limit of 75% by volume.

The materials IN 738, IN 738 LC, IN 939, PWA 1483 SX or IN 6203 DS can preferably be welded using the weld filler. The process using the inert gas mixture can also be used when welding without weld fillers.

FIG. 6 shows a perspective view of a blade or vane 120, 130 as an exemplary component 1, which extends along a longitudinal axis 121.

The blade or vane 120 may be a rotor blade 120 or guide vane 130 of a turbomachine. The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406.

As a guide vane 130, the vane may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials are used in all regions 400, 403, 406 of the blade or vane 120, 130.

The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes (not shown).

To protect against corrosion, the blade or vane 120, 130 has, for example, corresponding, generally metallic coatings, and to protect against heat it generally also has a ceramic coating.

FIG. 7 shows, by way of example, a partial longitudinal section through a gas turbine 100.

In the interior, the gas turbine 100 has a rotor 103 which is mounted such that it can rotate about an axis of rotation 102 and is also referred to as the turbine rotor.

An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burned in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 106, are subject to the highest thermal stresses.

To be able to withstand the temperatures which prevail there, they can be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776, EP 1 306 454, EP 1 319 729, WO 99/67435 or WO 00/44949; these documents form part of the disclosure.

The blades or vanes 120, 130 may likewise have coatings protecting against corrosion (MCrAlX; M is at least one element selected from the group consisting of iron (Fe), cobalt (Co), nickel (Ni), X is an active element and represents yttrium (Y) and/or silicon and/or at least one rare earth element) and heat as a result of a thermal barrier coating.

The thermal barrier coating consists for example of ZrO₂, Y₂O₄—ZrO₂, i.e. is unstabilized, partially stabilized or fully stabilized by yttrium oxide and/or calcium oxide and/or magnesium oxide.

Columnar grains are produced in the thermal barrier coating by means of suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1.-20. (canceled)

21. An inert gas mixture used during the welding of nickel- or cobalt-based substrates, consisting of:
helium and nitrogen; or
helium and hydrogen; or
helium, nitrogen, and hydrogen,
wherein the nitrogen is 1% by volume to 20% by volume,
wherein the hydrogen is 0.3% by volume to 25% by volume,
wherein the nitrogen is used to reduce a formation of low-melting phases on the grain boundaries or surfaces of the substrate, and
wherein the hydrogen is used to reduce an oxide formation.

22. The inert gas mixture as claimed in claim 21, wherein the inert gas mixture includes a nitrogen content of 3% by volume.

23. The inert gas mixture as claimed in claim 21, wherein the inert gas mixture includes a hydrogen content of 0.7% by volume.

24. A method for the welding of a substrate, comprising:
implementing the welding of the substrate using an inert gas mixture, the inert gas mixture, comprising:
helium and nitrogen, or
helium and hydrogen, or
helium, nitrogen and hydrogen,
wherein the nitrogen is 10% by volume to 20% by volume,
wherein the hydrogen is 0.3% by volume to 25% by volume,
wherein the nitrogen is used to reduce a formation of low-melting phases on the grain boundaries or surfaces of the substrate, and
wherein the hydrogen is used to reduce an oxide formation.

25. The method as claimed in claim 24, wherein a material of the substrate to be treated is a nickel- or cobalt-based material.

26. The method as claimed in claim 24, wherein the material of the substrate has a directionally solidified structure.

27. The method as claimed in claim 24,
wherein a weld filler is supplied to a surface of the substrate,
wherein the weld filler is melted, and
wherein the weld filler is left to solidify again.

28. The method as claimed in claim 27, wherein the molten weld filler is solidified so that the weld filler has a directionally solidified structure after the solidification.

29. The method as claimed in claim 24, wherein the material of the substrate is precipitation hardened.

30. The method as claimed in claim 24, wherein a maximum iron content of the material of the substrate is 1.5% by weight.

31. The method as claimed in claim 24, wherein the material of the substrate does not include any iron as an alloying constituent.

32. The method as claimed in claim 24, wherein the material of the substrate does not include nitrogen as alloying constituent.

33. The method as claimed in claim 25, wherein the nickel-based material of the substrate comprises a γ′ phase in a proportion of ≧35% by volume.

34. The method as claimed in claim 26, wherein a maximum proportion of the γ′ phase is 75% by volume.

35. The method as claimed in claim 25, wherein the nickel-based material of the substrate comprises IN 738 or IN 738 LC.

36. The method as claimed in claim 25, wherein the nickel-based material of the substrate comprises Rene 80.

37. The method as claimed in claim 25, wherein the nickel-based material of the substrate comprises IN 939.

38. The method as claimed in claim 25, wherein which the nickel-based material of the substrate comprises PWA 1483 SX or IN 6203 DS.

39. The method as claimed in claim 25, wherein the nickel-based material of the substrate differs from a material of the weld filler.

40. The method as claimed in claims 25, further comprising using an overageing heat treatment on the component prior to welding.
